(19) United States
(12) Patent Application Publication
(10) Pub. No.: US 2021/0272057 A1
(43) Pub. Date: Sep. 2, 2021

(54) SYSTEMS AND METHODS FOR A DELIVERY COMPLETION AUDIT TOOL

(71) Applicant: Coupang Corp., Seoul (KR)

(72) Inventors: Yulhee LEE, Seoul (KR); Namkyu JANG, Seoul (KR); Hyung LEE, Seoul (KR); Hoyeon BAE, Seoul (KR); Jaebong SUNG, Seoul (KR); Yonghee LEE, Seoul (KR); Yeonjung JO, Seoul (KR)

(21) Appl. No.: 16/805,684

(22) Filed: Feb. 28, 2020

(51) Int. Cl. G06Q 10/08; G06F 16/27; G06Q 30/06

(52) U.S. Cl. CPC G06Q 10/0835; G06Q 30/0641; G06F 16/27

(57) ABSTRACT

A computerized system for generating a single page user interface that includes a display, memory storing instructions, and at least one processor that may be configured to execute instructions to perform operations. The operations may include receiving an invoice ID for a customer from a first database, receiving delivery completion picture associated with the invoice ID from a second database, receiving a delivery information from a third database, generating a critical delivery information set and a data analytics set based on the invoice ID, the delivery completion picture, and the delivery information. Furthermore, the system may generate a single page user interface including information from the critical delivery information set and the data analytics set. Moreover, the single page user is displayed on the display wherein the single page user interface is configured to receive inputs from a user, and update the user interface in response to the received inputs.

### TECHNICAL FIELD

The present disclosure generally relates to computerized systems and methods for a delivery completion audit tool. In particular, embodiments of the present disclosure relate to inventive and unconventional systems for a single page user interface tool that helps an auditor search, review, audit, and confirm quality deliveries of parcels completed by delivery workers.

### BACKGROUND

The demand for fast and quality delivery of parcels may be growing every day. Consumers have become accustomed to the convenience offered by technological advances that increases their appetite for more and faster quality deliveries from companies. In return, companies have reacted to this mass increase in demand by not only increasing the number of their employees, but also hiring members of the community at large to meet those demands. However, while companies maintain the demand from consumers for more and faster deliveries, they have been unsuccessful at maintaining the quality of deliveries for their consumers.

Delivery completion auditing systems currently used in the industry may be limited in their ease of use and efficiency because auditors either manually acquire information from various databases or may be provided with a limited amount of information to rapidly and effectively audit the quality of deliveries. Furthermore, although limiting the amount of information to auditors may allow them to rapidly audit the quality of a deliveries, the audits may be not effectively performed because auditors do not have all the information necessary to make a qualified evaluation of a delivery.

Some delivery completion audit systems may be computerized; however, they may be limited in the amount of information displayed to auditors. For example, a delivery completion auditing system's user interface may be static in the information that it displays; thereby, limiting the information provided to an auditor. Furthermore, the conventional delivery completion auditing system's user interface may not dynamically respond to inputs provided by the auditor when the auditor attempts to obtain more information to make an informed quality delivery evaluation. Instead, auditors have to obtain investigative information from other databases or personnel, making the process very inefficient.

Therefore, there may be a need for an improved delivery completion audit tool that may be capable of receiving information from various databases, displaying relevant information to a user through a single page user interface, and dynamically updating the display based on user inputs or updated information received from the various databases.

### SUMMARY

One aspect of the present disclosure may be directed to a system for auditing delivery completion through a dynamic single page user interface. The system may comprise a display, a memory storing instructions and at least one processor configured to execute the instructions to perform operations. The operations may include receiving an invoice ID for a customer from a first database, receiving a delivery completion picture from a second database, receiving delivery information from a third database. Moreover, the operations may also comprise of generating a critical delivery information set and a data analytics set based on the invoice ID, the delivery completion picture, and the delivery information. In addition, the operations may also comprise generating a single page user interface including information from the critical delivery information set and the data analytics set. Furthermore, the system may display the single page user interface on the display where the single page user interface may be configured to receive inputs from a user, and the single page user interface may update the user interface in response to the user's received inputs.

Another aspect of the present disclosure may be directed to a method for auditing delivery completion through a dynamic single page user interface. The method may comprise the steps of receiving an invoice ID for a customer from a first database, receiving a delivery completion picture from a second database, receiving delivery information from a third database. Moreover, the steps may also comprise generating a critical delivery information set and a data analytics set based on the invoice ID, the delivery completion picture, and the delivery information. In addition, the method may also comprise generating a single page user interface including information from the critical delivery information set and the data analytics set. Furthermore, the method may display the single page user interface on the display where the single page user interface may be configured to receive inputs from a user, and the single page user interface may update the user interface in response to the user's received inputs.

Yet another aspect of the present disclosure may be directed to a computer-implemented system for auditing delivery completion that when executed by a least one processor, performs operations for generating a dynamic single page user interface. The operations may include receiving an invoice ID for a customer from a first database, receiving a delivery completion picture from a second database, receiving delivery information from a third database. Moreover, the operations may also comprise of generating a critical delivery information set and a data analytics set based on the invoice ID, the delivery completion picture, and the delivery information. In addition, the operations may also comprise generating a single page user interface including information from the critical delivery information set and the data analytics set. Furthermore, the system may display the single page user interface on the display where the user interface may include displaying at least a search criteria view, a critical delivery view, or an audit view. Moreover, the critical view may comprise displaying a list view and a detail invoice delivery view where the list view may include displaying a normal list view or a picture focus view. Additionally, the audit view may be displayed by the user providing inputs in the detail invoice delivery view. Moreover, the system may allow the single page user interface to be configured to receive inputs from a user, and to update the user interface in response to the received inputs from the user.

Other systems, methods, and computer-readable media may be also discussed herein.

### BRIEF DESCRIPTION OF THE DRAWINGS

FIG. 1A may be a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 depicts a schematic block diagram of an exemplary delivery completion auditing system consistent with the disclosed embodiments.

FIG. 4 is a diagrammatic illustration of an exemplary architecture of the delivery completion audit system, consistent with the disclosed embodiments.

FIG. 5A may be a diagrammatic illustration of an exemplary delivery completion audit system's single page user interface window, consistent with the disclosed embodiments.

FIG. 5B depicts a diagrammatic illustration of an exemplary Search Criteria View on the delivery completion audit system's single page user interface consistent with the disclosed embodiments.

FIG. 6A depicts a diagrammatic illustration of an exemplary Normal List View on the delivery completion audit system's single page user interface consistent with the disclosed embodiments.

FIG. 6B depicts a diagrammatic illustration of an exemplary Picture Focus View on the delivery completion audit system's single page user interface consistent with the disclosed embodiments.

FIG. 7 depicts a diagrammatic illustration of an exemplary Detail Invoice Delivery View on the delivery completion audit system's single page user interface consistent with the disclosed embodiments.

FIG. 8 depicts a diagrammatic illustration of an exemplary Audit History View on the delivery completion audit system's single page user consistent with the disclosed embodiments.

FIG. 9 depicts a diagrammatic illustration of an exemplary Detail Audit View on the delivery completion audit system's single page user interface consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure may be directed to systems and methods configured for a delivery completion audit tool.

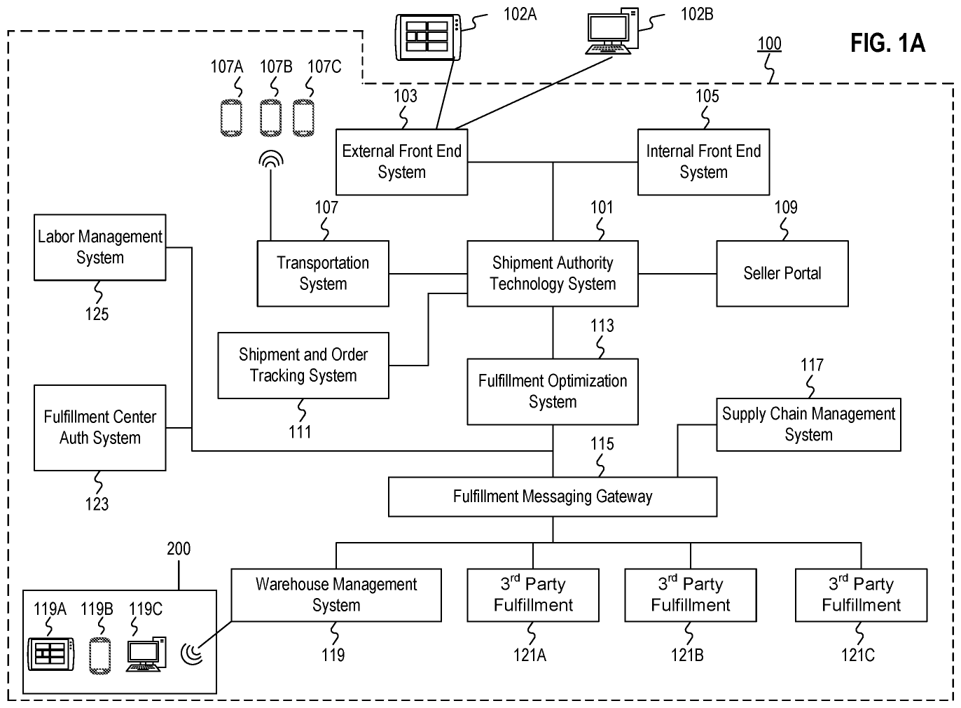

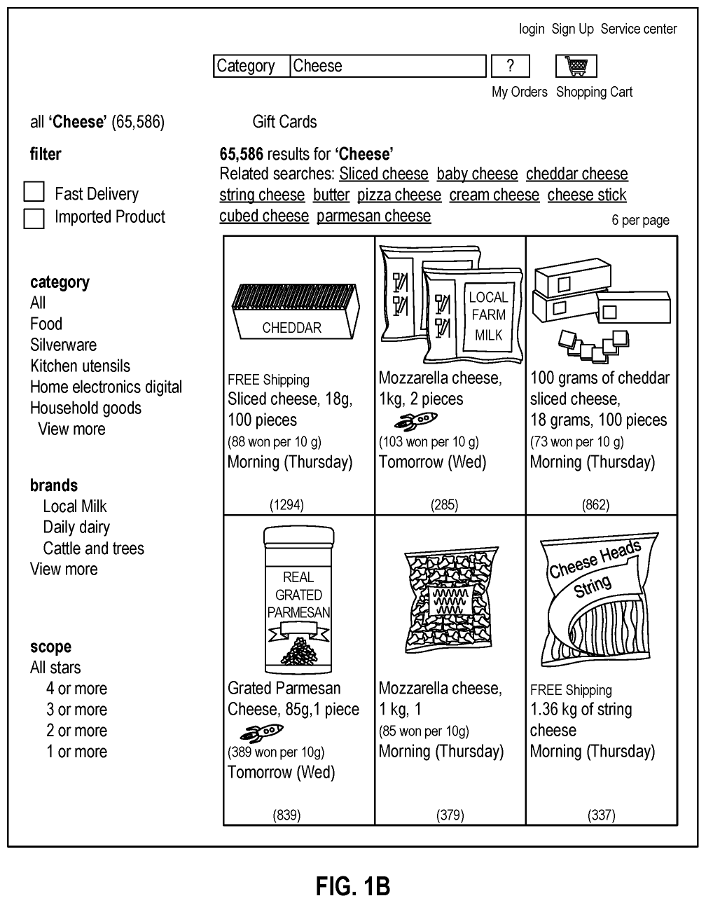

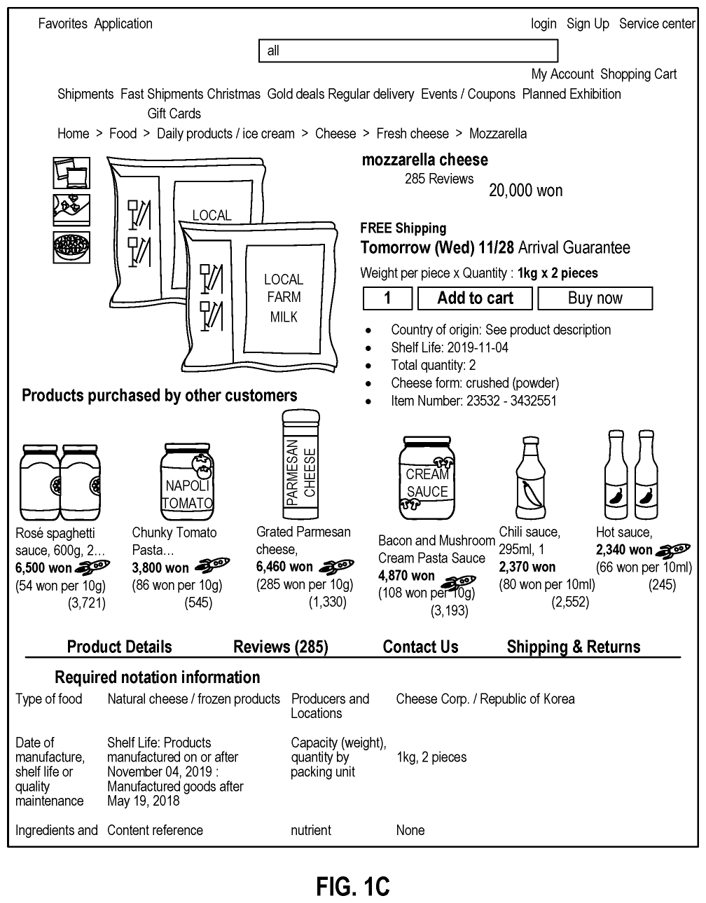

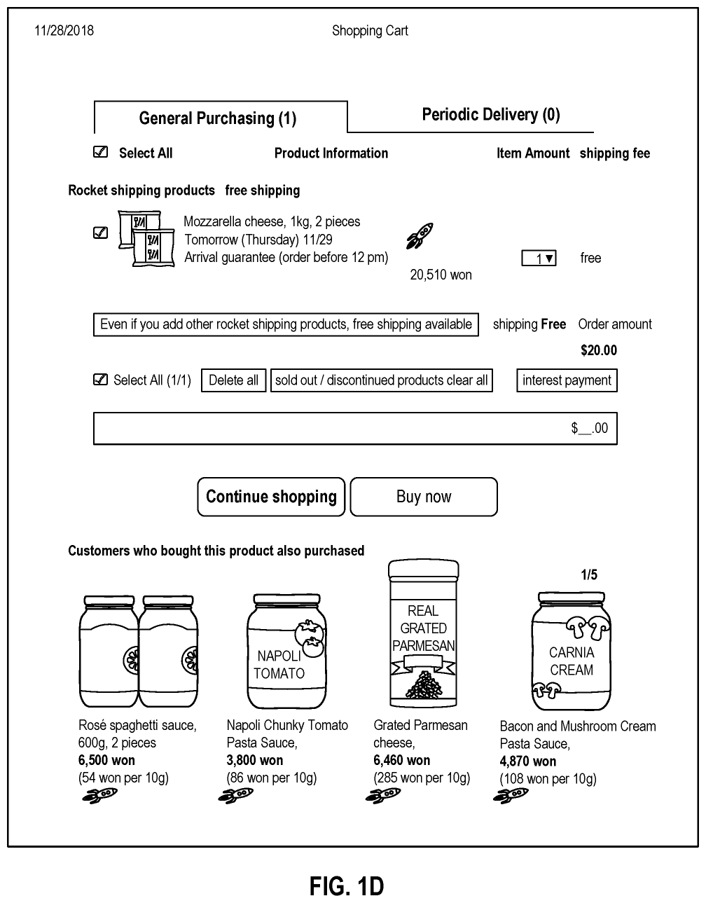

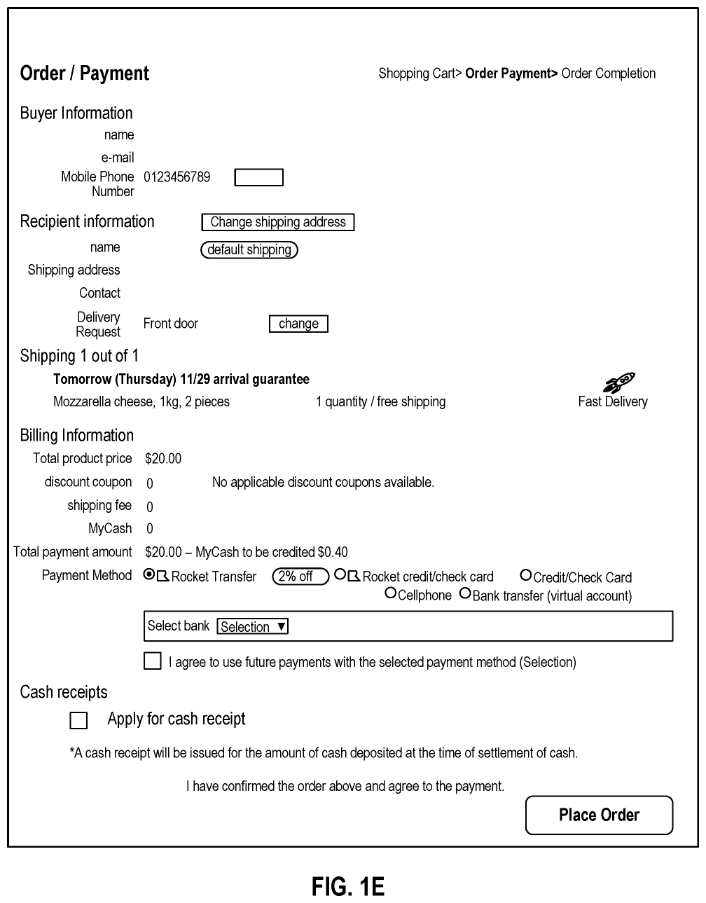

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count of products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

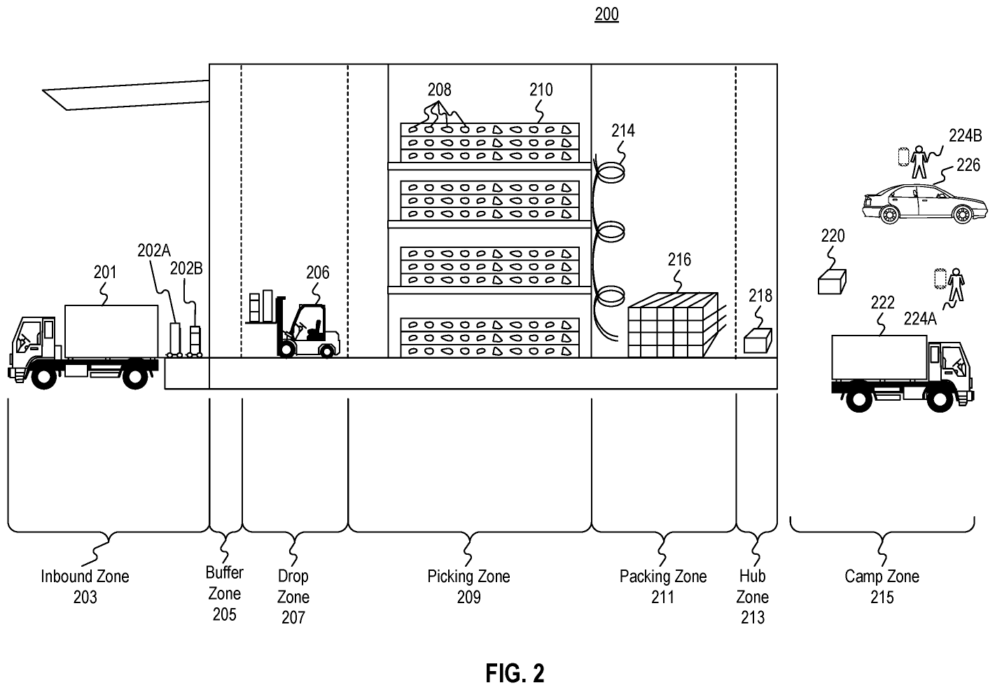

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1196.

Once a user places an order, a picker may receive an instruction on device 1196 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

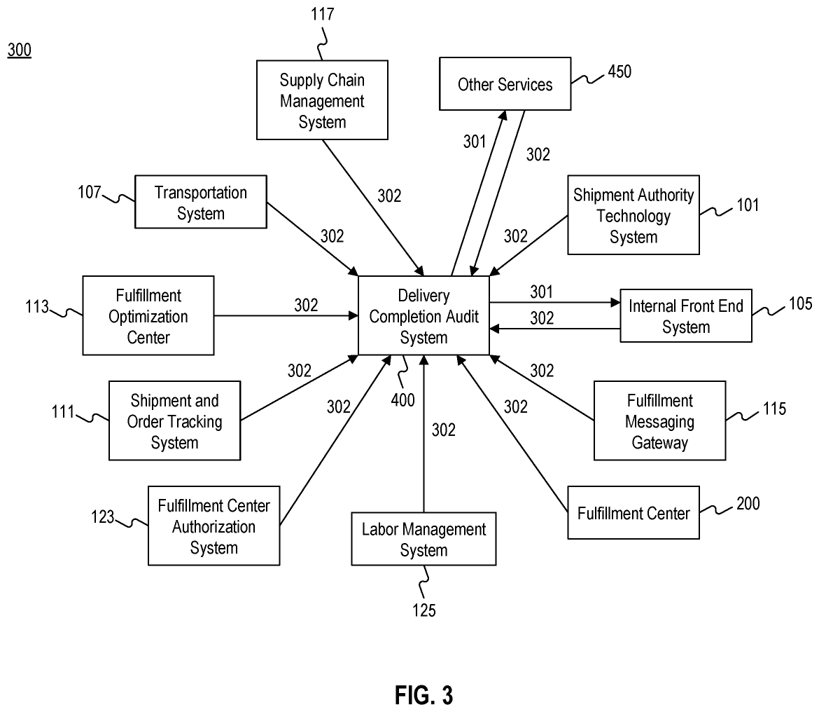

FIG. 3 is a schematic block diagram of an exemplary delivery completion auditing system 300, consistent with disclosed embodiments. System 300 may include Delivery Completion Audit System 400 interacting and communicating with one or more databases or servers such as Transportation system 107, Fulfillment Optimization Center 113, Shipment and Order Tracking System 111, Fulfillment Center Authorization System 123, Labor Management System 125, Fulfillment Center 200, Fulfillment Messaging Gateway 115, Shipment Authority Technology System 101, etc. by receiving information through one or more network connections 302. Delivery Completion Audit System 400 may send its user interface display and information via one or more network connection 301 to the Internal Front End System 105 where users, such as, auditors interact with the system by sending commands and information back to Delivery Completion Audit System 400 through one or more network connections 302. In another exemplary embodiment, Delivery Completion Audit System 400 may receive commands and information from Other Services Module 450 via one or more network connections 301. Delivery Completion Audit System 400 may send commands and information via one or more network connections 301 back to Other Services Module 450. Other Services Module 450 may include one or more servers and/or databases that may request an audit status for one or more deliveries. Delivery Completion Audit System 400 may additionally or alternatively obtain information from the one or more databases or servers to update its generated data.

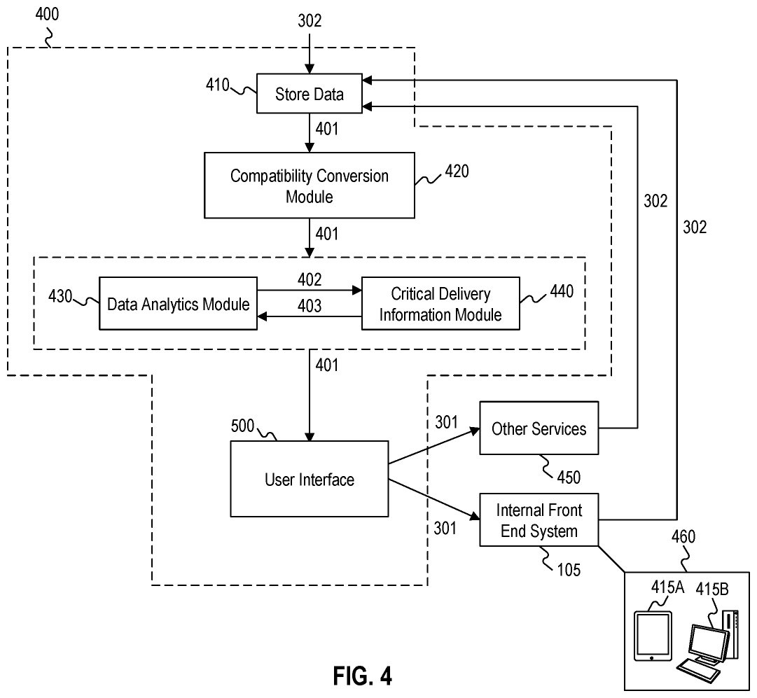

FIG. 4 is a diagrammatic illustration of an exemplary embodiment of the Delivery Completion Audit System 400. System 400 may comprise Store Data 410, Compatibility Conversion Module 420, Data Analytics Module 430, Critical Delivery Information Module 440, User Interface 500, Other Services Module 450, and Auditors 460. In one exemplary embodiment, Store Data 410, Compatibility Conversion Module 420, Data Analytics Module 430, Critical Delivery Information Module 440, and User Interface 500 may include modules that reside on a single server comprising of a plurality of processing units to efficiently execute its tasks. In other exemplary embodiments, one or more of Store Data 410, Compatibility Conversion Module 420, Data Analytics Module 430, Critical Delivery Information Module 440, User Interface 500, Other Services Module 450 may reside on different platforms (e.g. different servers or devices). In one exemplary embodiment, system 400, may receive via one or more network connections 302 delivery information from one or more databases and/or servers in System 300. Delivery Completion Audit System 400 may Store Data 410 received from the one or more databases and/or servers in System 300. Stored data 410 may be received by Delivery Completion Audit System 400 in a plurality of formats. Delivery Completion Audit System 400 may send Store Data 410 via one or more network connections 401 to transform, index, rearrange, filter, and standardize Store Data 410 via Compatibility Conversion Module 420. For example, in one exemplary embodiment, data received may be in binary format, archive file formats, picture file formats, data file formats, database file formats, document file formats, misc. formats, or the like. Compatibility Conversion Module 420 may then convert the data from their individual formats to Compatibility Conversion Module 420's own format for manipulation, thereby transforming the data for more efficient usage. Further, the transformed data may then be indexed according to associated information, rearranged for associated information to be paired together, filtered for wanted and not complete information to be later arranged with its proper associated information; thus, Compatibility Conversion Module 420 may standardize Store Data 410 of efficient and fast usage in Data Analytics Module 430, Critical Delivery Information Module 440, and User Interface 500. In yet another embodiment, Compatibility Conversion Module 420 may include one or more computing devices configured with appropriate hardware and software to perform operations consistent with transforming, indexing, rearranging, filtering, and standardizing Store Data 410.

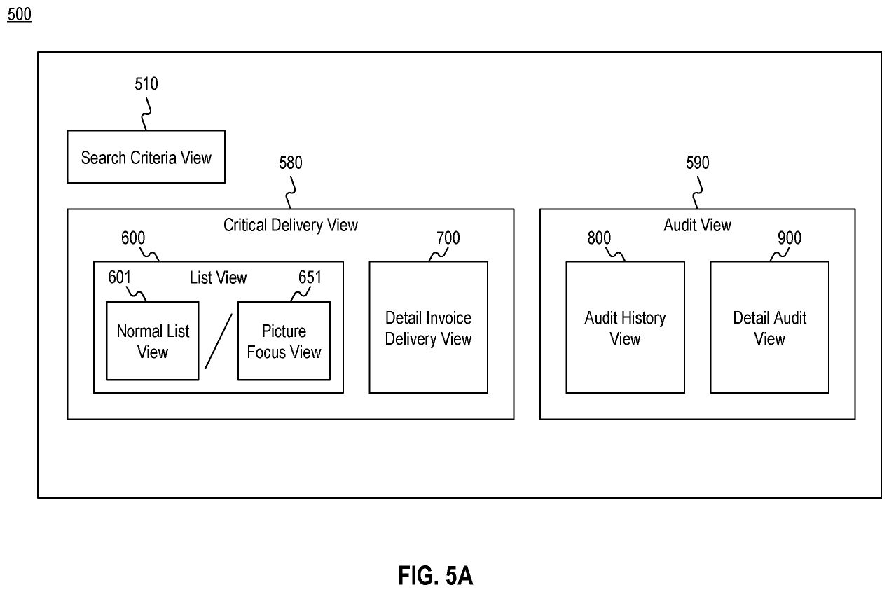

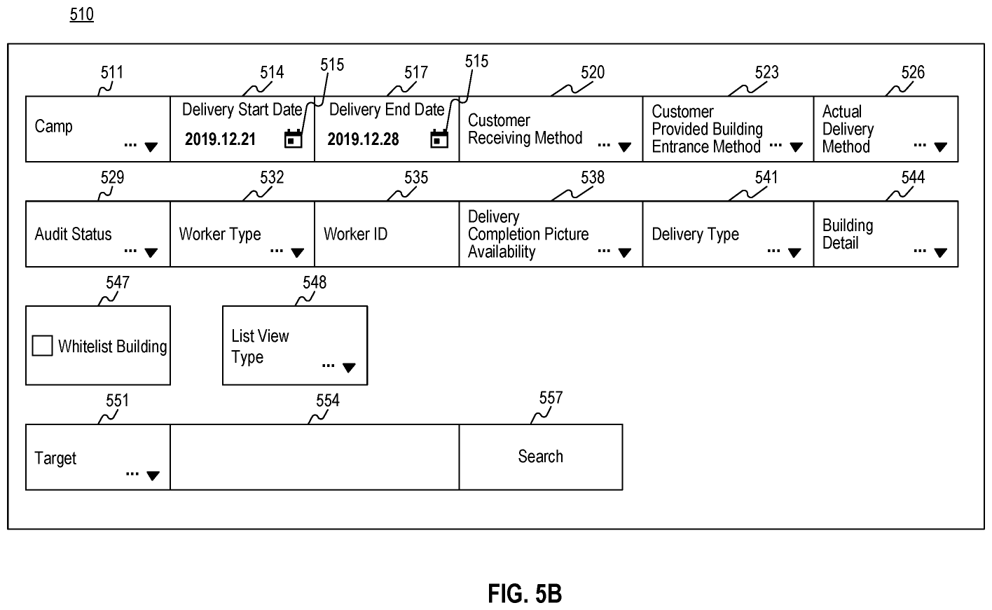

Compatibility Conversion Module 420 may send via one or more network connections 401 the transformed, indexed, filtered, rearranged, and standardized information to Critical Delivery Information Module 440 and Data Analytics Module 430. Critical Delivery Information Module 440 and Data Analytics Module 430 may include one or more computing devices configured with appropriate hardware and software to perform operations. Critical Delivery Information Module 440 may generate a critical delivery information set. The critical delivery information set may include delivery information for auditors 460 to effectively complete their auditing task. For example, as further described below and in FIGS. 5B-9, the delivery information set may comprise invoice ID, order ID, delivery start date, the delivery start time, the delivery completion date, the delivery completion time, the delivery completion duration, the camp where the parcel or package was obtained by the delivery worker, the delivery worker type, the delivery worker ID, the customer receiving method, the customer address, the actual delivery method, the delivery completion picture, the delivery type, the building entrance method by the delivery worker, whitelist building information, and the audit status—the list provided above may include more information further described below.

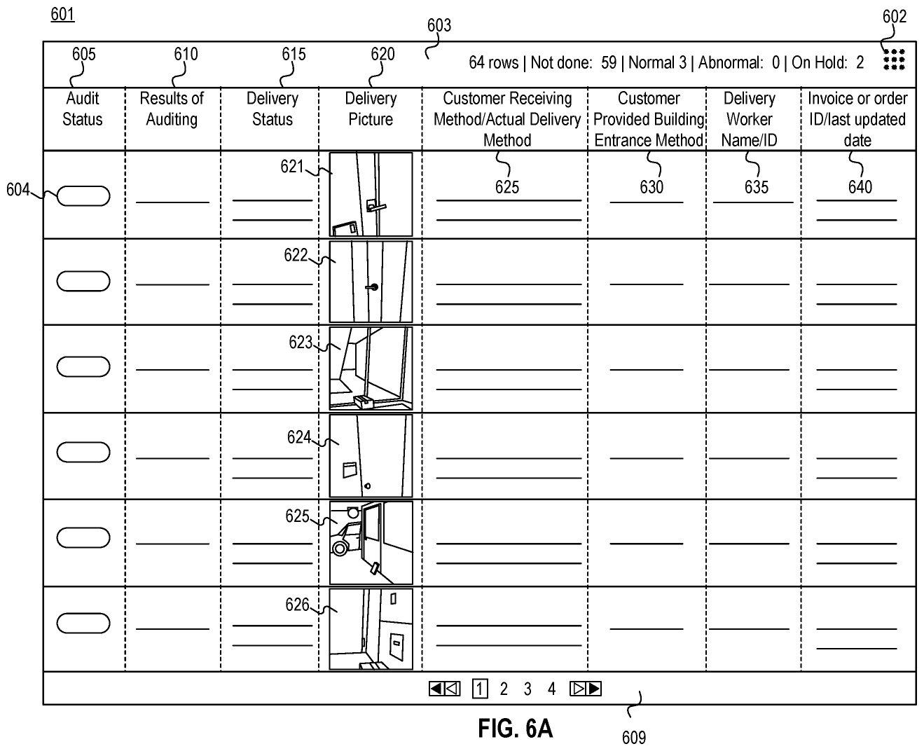

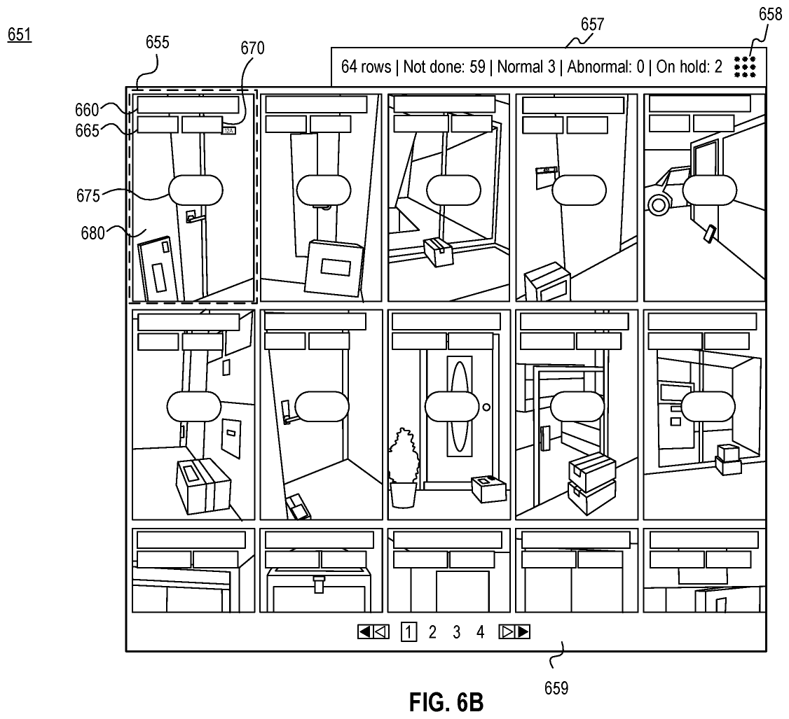

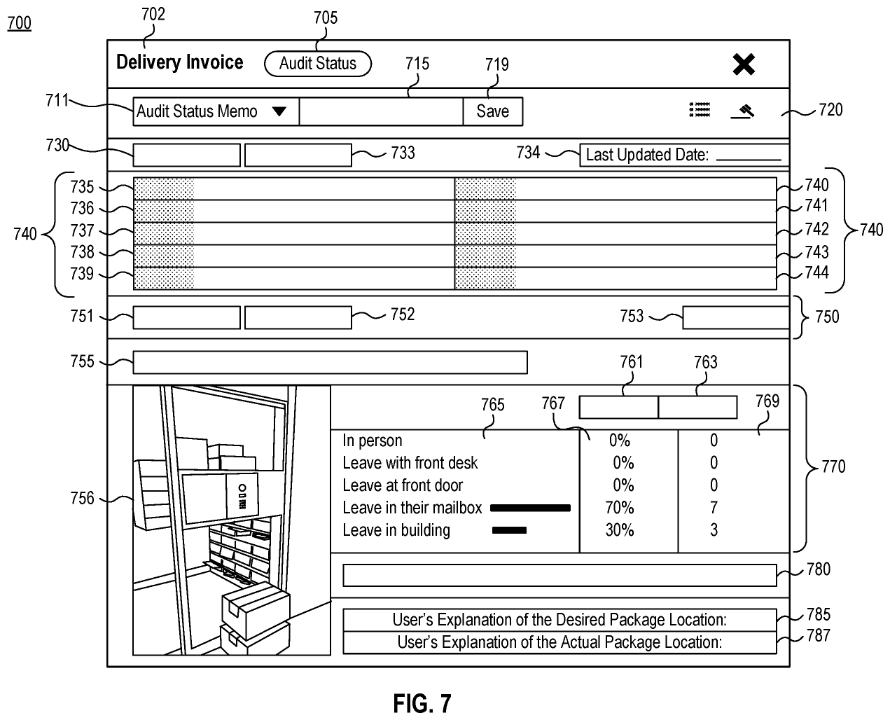

Data Analytics Module 430 may generate a data analytics set including past delivery information associated with Critical Delivery Information Module 440 to additionally create statistical data. For example, as further described in FIGS. 6A-7, the data analytics set may comprise of the percentage and number of successful deliveries executed to an address, the percentage and number of unsuccessful deliveries executed to an address, invoice or order ID that may be associated with an address or customer, the total number of completed deliveries by dates, the total number of deliveries that did not match the customer's delivery request, the total number of deliveries with a delivery picture, the total number of deliveries without a delivery picture, the indexing and association of information as they related to each other by time, date, invoice ID, order ID, address, worker type, delivery type, audit status, and whitelist building. The list provided above may include more information further described below.

The critical delivery information set and data analytics set may include current, updated, and revised information provided by users—auditors 460 and/or Other Services Module 450—and/or by one or more of the plurality of databases and servers. Data Analytics Module 430 and Critical Delivery Information Module 440 may efficiently communicate and exchange data via one or more network connections 402 and 403 to ensure that both may continually and dynamically be updated and synced with new delivery information provided by through one or more network connections 302 from one or more databases and servers in System 300.

In one exemplary embodiment, Data Analytics Module 430 and Critical Delivery Information Module 440 may reside on the same platform (e.g. same computing device or server). Information generated by Data Analytics Module 430 and Critical Delivery Information Module 440 may be sent to single page User Interface 500 via one or more network connections 401. Auditors 460 may utilize one or more devices such as tablet or PDA 415A, computers 4156, or the like to access the User Interface 500 to perform their auditing task. Auditors 460 may access User Interface 500 via Internal Front End System 105, which may receive data from Delivery Completion Audit System 400 via one or more network connections 301. Other Services Module 450 may access the single page User Interface 500 via one or more network connections 301. User Interface 500 may provide users such as auditors 460 and Other Services Module 450 with real time display of commands and inputs provided by auditors 460 and Other Services Module 450 via one or more network connections 302. User Interface 500 may be constantly being updated not only with data received from Data Analytics Module 430 and Critical Delivery Information Module 440, but it also dynamically updates itself with users inputs.

FIG. 5A may be an illustration of an exemplary embodiment of User Interface 500. User Interface 500 may comprise of Search Criteria View 510, Critical Delivery View 580, and Audit View 590. User Interface 500 may dynamically adjust its display based on inputs provided by user(s)—Auditor(s) 460 or Other Services Module 450 where Search Criteria View 510 and/or Critical Delivery View 580 and/or Audit View 590 are displayed. For example, in one exemplary embodiment, User Interface 500 only displays Search Criteria View 510 so users may perform a search. In other exemplary embodiments, depending on the inputs provided by users in Search Criteria View 510, User Interface 500 may display Search Criteria View 510 and Critical Delivery View 580. In yet other exemplary embodiments, User Interface 500 may display Search Criteria View 510, Critical Delivery View 580, and Audit View 590. In another embodiment, one or more elements of information displayed on User Interface 500 may be modified based on commands or inputs received from users.

Critical Delivery View 580 may include List View 600 and/or Detail Invoice Delivery View 700. List View 600 may include Normal List View 601 or Picture Focus View 651. Based on the inputs and commands provided by users in Search Criteria View 510, List View 600 may either be displayed with Normal List View 601 or Picture Focus View 651. Normal List View 601 and Picture Focus View 651 are further described below in FIGS. 6A and 6B, respectively. In one exemplary embodiment, User Interface 500 may dynamically display Critical Delivery View 580 with only Normal List View 601 or Picture Focus View 651 based on the inputs and commands provided by users in Search Criteria View 510. For example, when a user interacts with items in Normal List View 601 or Picture Focus View 651, User Interface 500 may display Detail Invoice Delivery View 700. Detail Invoice Delivery View 700 is further described below in FIG. 7.

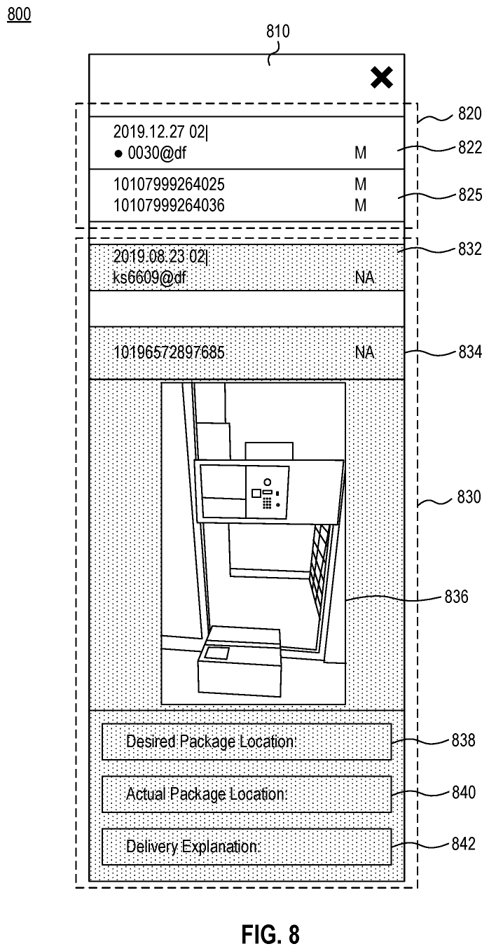

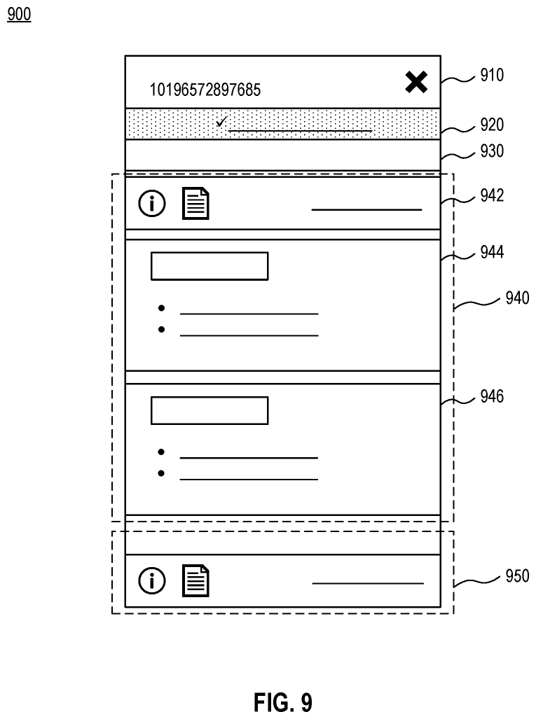

Audit View 590, in User Interface 500, may comprise Audit History View 800 and/or Detail Audit View 900. Audit History View 800 and Detail Audit View 900 are further described below in FIGS. 8 and 9, respectively. In one exemplary embodiment of User Interface 500, when a user interacts with items in Detail Invoice Delivery View 700, User Interface 500 may display Audit History View 800. User Interface 500 may display Critical Delivery View 580 along with Audit History View 800. In another exemplary embodiment, when a user interacts with items in Audit History View 800, User Interface 500 may display Detail Audit View 900. User Interface 500 may display Critical Delivery View 580, Audit History View 800, and Detail Audit View 900 side-by-side on the same display. Search Criteria View 510, Critical Delivery View 580, and Audit View 590 may allow users to dynamically interact with User Interface 500 to acquire information from Data Analytics Module 430 and Critical Delivery Information Module 440 modules for efficient and fast audit status, audit completion inputs, and/or audit completion updates. Moreover, Data Analytics Module 430 and Critical Delivery Information Module 440 may continually update and acquire more information as users provide Delivery Completion Audit System 400 with new information or revised information.

FIG. 5B is an illustration of an exemplary embodiment of Search Criteria View 510. Search Criteria View 510 may comprise information generated by Critical Delivery Information Module 440 that may be available for users to perform a search. Search Criteria View 510 may also comprise the drop-down menu Camp 511, the date search field Delivery Start Date 514, the date search field Delivery End Date 517, the drop down menu Customer Receiving Method 520, the drop down menu Customer Provided Building Entrance Method 523, the drop down menu Actual Delivery Method 526, the drop down menu Actual Status 529, the drop down menu Worker Type 532, the search box Worker ID 535, the drop down menu Delivery Completion Picture Availability 538, the drop down menu Delivery Type 541, the drop down menu Building Detail 544, the radio button Whitelist Building 547, the drop down menu List View Type 548, the drop down menu Target 551, Search Box 554, and Search Button 557.

Search Criteria View 510 may be arranged the search fields mentioned above in an array configuration where, for example, Camp 511, Delivery Start Date 514, Delivery End Date 517, Customer Receiving Method 520, Customer Provided Building Entrance Method 523, and Actual Delivery Method 526 may be arranged adjacent to each other in a row. Further, Search Criteria View 510 may also arrange Audit Status 529, Worker Type 532, Worker ID 535, Delivery Completion Picture Availability 538, Delivery Type 541, and Building Detail 544 on another row adjacent to each other. Moreover, Search Criteria View 510 may arrange radio button Whitelist Building 547 and List View Type 548 on another row where they are adjacent to each other. Furthermore, Search Criteria View 510 may arrange Target 551, Search Box 554, and Search Button 557 in another row where they are adjacent to each other. Although FIG. 5B may illustrate one arrangement of Search Criteria View 510, other arrangements may be possible. The particular data describe below with respect to each element in FIG. 5B is exemplary and other data/types of data may be present in some embodiments. In one exemplary embodiment, Search Criteria View 510 may allow users to initiate searches using pre-configured drop down menus. For example, such pre-configured menus may include: Camp 511, Customer Receiving Method 520, Customer Provided Building Entrance Method 523, Actual Delivery Method 526, Audit Status 529, Worker Type 532, Delivery Completion Picture Availability 538, Delivery Type 541, Building Detail 544, and Target 551.

Selecting Camp 511 from the drop down menus may allow a user to narrow the search to a specific camp name where each camp may be a representation of a city or town area broken in zones. Delivery workers may pick up or return parcels or packages at Camp Zone 215, which are given specific names.

Selecting Customer Receiving Method 520 may allow users to narrow their search from options comprising customer's delivery instruction methods such as “in person deliveries,” “front door deliveries,” “front desk deliveries,” “mailbox” deliveries, “In building” deliveries, and “building entrance deliveries.”

Selecting Customer Provided Building Entrance Method 523 may allow users to narrow their search from options comprising customer's building entrance instructions such as “building entrance codes” or specific instructions provided by the customer.

Selecting Actual Delivery Method 526 may allow users to narrow their search from options comprising delivery worker's actual delivery of parcels or packages either consistent or inconsistent with Customer Receiving Method 520 such as “in person deliveries,” “front door deliveries,” “front desk deliveries,” “mailbox” deliveries, “In building” deliveries, and “building entrance deliveries.”

Selecting Audit Status 529 may allow users to narrow their search from options comprising previously entered Auditors 460's delivery audit status such as “Normal” status, “Not done” status—meaning the delivery inspection may not have yet been performed by Auditors 460, “On Hold” status—meaning the delivery inspection by Auditors 460 may need further investigation, and “Abnormal” status—meaning the delivery may not have properly been executed by the delivery worker.

Selecting Worker Type 532 may allow users to narrow their search from options comprising employees or temporary, contract, or flex-schedule workers (Flex delivery workers).

Selecting Delivery Completion Picture Availability 538 may allow users to narrow their search from options comprising “Yes” when a delivery picture may have been taken by the delivery worker, or “No” when a delivery picture may not have been taken by the delivery worker.

Selecting Delivery Type 541 may allow users to narrow their search from options comprising “Dawn” deliveries—meaning deliveries executed at dawn or early morning—, “Day” deliveries—meaning deliveries executed during business hours—, “Evening” deliveries—meaning deliveries executed in the evening—, and “Overnight” deliveries—meaning deliveries executed overnight.

Selecting Building Detail 544 may allow users to narrow their search from options comprising “Apartment Complex”, “Single Family Home”, or “Office Building.” List View Type 548 may allow users to display List View 600 in either Normal List View 601 or Picture Focus View 651.

Selecting Target 551 may allow users to set their search options according to a delivery “invoice ID” or “order ID.” For example, in one exemplary embodiment, based on Target 551 selected by the users, the users may either enter the invoice ID or the order ID in Search Box 554 where users may execute their search by pressing Search Button 557. In another exemplary embodiment, users may perform a wild card search by entering the beginning ID numbers proceeded by a “*” or the end ending ID numbers preceded by a “*” inside Search Box 554 based on Target 551 selection.

Selecting Delivery Start Date 514 and/or Delivery End Date 517 may allow users to search deliveries from a specific date or a range of dates. Delivery Start Date 514 and/or Delivery End Date 517 may allow users to select a date by clicking on icon 515 inside 514 to obtain a calendar view from which users may select a specific delivery start date. Similarly, users may also click on icon 515 inside 517 to select a specific delivery end date. For example, in one exemplary embodiment, Search Criteria View 510 may allow users to narrow their search to a specific date by selecting the same date in Delivery Start Date 514 and Delivery End Date 517. In another exemplary embodiment, Search Criteria View 510 may also allow users to select from a range of delivery dates from Delivery Start Date 514 to Delivery End Date 517. In yet another exemplary embodiment, Search Criteria View 510 may also allow users to select a range of delivery dates starting from Delivery Start Date 514 to the users' present day. In yet another exemplary embodiment, Search Criteria View 510 may also allow users to select a range of delivery dates starting from Delivery End Date 517 to all earlier deliveries.

Searching with the search box Worker ID 535 may allow users to further restrict their searches according to a specific delivery worker ID. For example in one exemplary embodiment, a user may be interested in knowing deliveries associated with a delivery worker ID of interest; the user may enter the delivery worker ID in the search box for Worker ID 535. In another exemplary embodiment, users may perform a wild card search by entering the beginning ID numbers proceeded by a “*” or the end ending ID numbers preceded by a “*.”

Selecting the radio button for Whitelist Building 547 may allow users to restrict the search by users to only include buildings with special designations where delivery workers may be provided with special access.

In one exemplary embodiment, once users have selected from among the search options provided in Search Criteria View 510, users can press Search Button 557 to execute the search. In yet another embodiment of Search Criteria View 510, a user may perform a global search listing all deliveries without relying on the pre-configured drop-down menus, Worker ID 535, Search Box 554, and/or the radio button Whitelist Building 547. Users may narrow their search with the use of at least one pre-configured drop-down list. Users may also narrow their search by entering part of the invoice or order ID in Search Box 554. In response, Delivery Completion Audit System 400 may provide all invoice or order IDs associated with the entered part of the invoice ID or order ID.

FIG. 6A may be an illustration of an exemplary embodiment of Normal List View 601. Normal List View 601 may also utilize items from Critical Delivery Information Module 440 and Data Analytics Module 430 to arrange executed deliveries in a way that users may easily identify issues relating to a specific delivery. In one embodiment, Normal List View 601 may comprise of a table with six results from a search in Search Criteria View 510 each listed in rows and arranged by columns with Audit Status 529 in 605, Results of Auditing 610, Delivery Status 615—meaning “completed,” “in-progress,” or “not complete” deliveries—, Delivery Picture 620, Customer Receiving Method 520 and Actual Delivery Method 526 in 625, Customer Provided Building Entrance Method 523 in 630, Delivery Worker Name and ID 635, depending on Target 551's selection, the invoice or order ID with a date for any updates that may be performed by users in 640, information relating to a data analytics set in Data Analytics Module 430 that may be based on users search in Search Criteria View 510 in 603, further described below, icon 602 providing users the ability to toggle between Normal List View 601 and Picture Focus View 651, and at the bottom of the table, the ability for users to navigate to different pages by either clicking the numbers or the arrows in 609.

Moreover, in yet another exemplary embodiment, Normal List View 601, based on a search performed in Search Criteria View 510, may allow users to quickly identify the total number of invoice or order ID, the total number of “Not done,” “Normal,” “Abnormal,” and “On Hold” delivery audits in 603. Furthermore, In yet another embodiment of Normal List View 601, Oval Shape 604 may provide users with an efficient way of identifying the type of Audit Status 529 in 605 for a specific invoice or order ID. Each Oval Shape 604 may be color coded according to the type of Audit Status 529 in 605. For example, “Not done” may have the color grey; “Normal” may have the color blue; “On Hold” may have the color orange; and “Abnormal” may have the color red. The color codes in 604 may allow users to quickly and efficiently identify at least one invoice to work on. For example, in an exemplary embodiment, the delivery picture in 621 on the first row may display a package delivered in front of an apartment's front door with Audit Status 605 “Not done” in 604, the delivery picture in 622 on the second row may display only a building's front door without a package with Audit Status 605 “Not done” in 622's respective Audit Status 604, the delivery picture in 623 on the third row may display a package in front of a building's front door with Audit Status 605 “Normal” in 623's respective 604—based on entries in 615, 625, and 630—, the delivery picture in 624 on the fourth row may display only the apartment's front door without a package with Audit Status 605 “Normal” in 624's respective 604—based on entries in 615, 625, and 630—, the delivery picture in 625 on the fifth row may display a package placed outside a home's front door with Audit Status 605 “On Hold” in 6254's respective 604—based on entries in 615, 625, and 630—, and the delivery picture in 626 on the sixth row may display a package next to a mail box at the entrance of a building with Audit Status 605 “On Hold” in 626's respective 604—based on entries in 615, 625, and 630.

FIG. 6B may be an illustration of an exemplary embodiment of Picture Focus View 651. Picture Focus View 651 may provide users with an alternate efficient display of Critical Delivery Information Module 440 and Data Analytics Module 430 by arranging Delivery Pictures 680 in cells 655 inside a table array. Just as Normal List View 601, Picture Focus View 651 may comprise, based on a search performed on Search Criteria View 510, the display of data analytics set information in 657—displaying the total number of invoice or order ID, the total number of “Not done,” “Normal,” “Abnormal,” and “On Hold” delivery audits—, the icon 658 providing users the ability to toggle between Normal List View 601 and Picture Focus View 651, the dominantly displayed Delivery Picture 680 in 655, the display of Customer Receiving Method 523 and Customer Provided Building Entrance Method 523 in 660, the display of Actual Delivery Method 526 in 665, the display of Building Detail 544 in 670, Oval Shape 675 inside cell 655 providing the Audit Status 529 or 605's options—“Not done;” “Normal,” “On Hold,” and “Abnormal”—, and at the bottom of the table, the ability for users to navigate to different pages by either clicking the numbers or the arrows in 659.

In one exemplary embodiment, Picture Focus View 651 may allow users to efficiently assess the quality of a delivery from the dominantly displayed Delivery Picture 680 in 655 or the other remaining nine delivery pictures in Picture Focus View 651, which may also display the Customer Receiving Method 523 and Customer Provided Building Entrance Method 523 in 660, Actual Delivery Method 526 in 665, and Building Detail 544 in 670. Moreover, Oval Shape 675 inside 655 may provide users the ability to efficiently see Delivery Picture 680's Audit Status 529 or those of the other 9 delivery pictures, which may also be color coded according to Audit Status 529's options—“Not done;” “Normal,” “On Hold,” and “Abnormal.”

In yet another exemplary embodiment of Picture Focus View 651, users may directly audit and enter the status of deliveries. For example, users may select a specific cell 655 or the cell from the other nine delivery pictures, and may then click once on Delivery Picture 680 to change its Audit Status 529 to “Normal.” In addition, users may also, after selecting a specific cell 655, double-click Delivery Picture 680 to change its Audit Status 529 to “On Hold.” Furthermore, users may, after selecting a specific cell 655, triple-click Delivery Picture 680 to change Audit Status 529 to “Abnormal.” Moreover, users may, after selecting a specific cell 655, quadruple-click Delivery Picture 680 to change its Audit Status 529 to “Not done.”

FIG. 7 is an illustration of an exemplary embodiment of Detail Invoice Delivery View 700. Detail Invoice Delivery View 700 may provide users with additional current and historical Critical Delivery Information Module 440 and Data Analytics Module 430 for all invoices or orders associated with an address from selecting a row inside Normal List View 601 or a cell 655 in Picture Focus View 651. In an exemplary embodiment of Critical Delivery View 580, once a user selects a row inside Normal List View 601 or a cell 655 inside Picture Focus View 651, Detail Invoice Delivery View 700 may be dynamically displayed alongside Normal List View 601 or Picture Focus View 651. In another exemplary embodiment, Detail Invoice Delivery View 700 may dynamically be updated when a user clicks or selects another row inside Normal List View 601 or another cell 655 inside the delivery pictures available on Picture Focus View 651.

Detail Invoice Delivery View 700 may comprise a delivery invoice or order 702—the invoice or the order may be displayed according to the type of search selected in Target 551 inside Search Criteria View 510—and Audit Status 529 in 705. Moreover, users may enter a memo related to Audit Status 529 that may have been assigned to a row inside Normal List View 601 or a cell 655 in Picture Focus View 651 inside box 715. The user may then click Save 719 to propagate the change inside Delivery Completion Audit System 400. Memo entries—explanations related to a certain delivery picture success and discrepancy—may be provided by users to store and process (Store Data 410 and Compatibility Conversion Module 420) in Delivery Completion Audit System 400 for updating Critical Delivery Information Module 440 and Data Analytics Module 430. The memo entries provided by users may be accessible as templates under the Audit Status Memo drop-down list 711 for future or current users.

Moreover, Detail Invoice Delivery View 700 may further comprise the invoice or order ID—depending on Target 551's selection—displayed in 730, Actual Delivery Method 526 displayed in 733, and the last date for an update by a user or delivery worker displayed in 734. Furthermore, Detail Invoice Delivery View 700 may comprise of Table 740 listing Order ID 735, Invoice ID 736, Delivery Status 615 in 737, Delivery Type 541 in 738, Customer Receiving Method 520 in 739, Invoice ID 736 or Order ID 735's Order Date and Time 740, Expected Delivery Date 741, Actual Delivery Date and Time 742, the delivery worker's Worker ID 743, and the Flex delivery worker's Worker ID 744.

Moreover, Detail Invoice Delivery View 700 may also comprise of 750, which includes Customers Provided Building Entrance Method 523 in 751 and its option in 752, Customer's Name 753. In addition, Detail Invoice Delivery View 700 may also comprise Delivery's Address 755, Delivery Picture 620 or 680—associated with Delivery's Address 755 and the selected row inside Normal List View 601 or cell 655 in Picture Focus View 651—in 756, and statistical information based on historical data processed from the same delivery address for a plurality of invoice or order ID in 770. More specifically, 770 may comprise Percentage of Successful Deliveries 761, Number of Successful Deliveries 763 by delivery workers according to Customer Receiving Method 520's options in 765 may be listed under 767 and 769 respectively. Additionally, Detail Invoice Delivery View 700 also may comprise of memo entries from past users in 780, Users' Explanations of the Desired Package Location 785, and Users' Explanations of the Actual Package Location 787.

FIG. 8 may be an illustration of an exemplary embodiment of Audit History View 800. In another exemplary embodiment of Audit View 590, when a user clicks on a specific row containing Customer Receiving Method 502's options, Percentage of Successful Deliveries 761 in 765, or Number of Successful Deliveries 763 in 769 inside Detail Invoice Delivery View 700, Audit History View 800 may be displayed. Audit History View 800 may comprise of the title Delivery History in 810 and one or more deliveries in 820 or 830 for the same address' Delivery Address 755, which may be based on users' selection or click of a specific row containing Customer Receiving Method 502's options, Percentage of Successful Deliveries 761 in 765, or Number of Successful Deliveries 763 in 769 inside Detail Invoice Delivery View 700.

In another exemplary embodiment 820, may further provide Actual Delivery Date 822, and all previous invoice or order ID in 825 for that same address on the same Actual Delivery Date 822. For example, in one exemplary embodiment, when users may click or select one of the plurality of deliveries for the same address listed under 830, 830 may expand to provide users with Actual Delivery Date 832, the invoice or order ID under 834, Delivery Picture 620 or 680, user's entries of Desired Package Location 838, Actual Package Location 840, and previous user's entries of Delivery Explanation 842 discrepancies for the same Delivery Address 755.

In yet another exemplary embodiment, users may further scroll through other plurality of deliveries to get a better idea of the history with deliveries at a specific Delivery Address 755 for memo entries inside 720 or 940, further provided below.

FIG. 9 may be an illustration of an exemplary embodiment of Detail Audit View 900. In one exemplary embodiment, when users may click or select a plurality of deliveries under 820 or 830 of the Audit History View 800, Detail Audit View 900 may dynamically be displayed, which may allow users to further enter detailed memo entries about the invoice or order ID selected in 834. Detail Audit View 900 may comprise of the invoice or order ID in 910, users' ability to enter generic memo entries in 930, and user's ability to enter additional more detail memos in 940 or 950. In yet another exemplary embodiment, users may enter more detail memo information about discrepancies or resolutions related to a delivery for auditing purposes inside 944 or 946. For example, in one exemplary embodiment, users may add more specific detail memos by clicking 942, which may expand the view to provide 944 under 942. In yet another exemplary embodiment, users may create additional memo entry such as 946 by further clicking on 942.

In yet another exemplary embodiment, at a later date, the next user may click on 950 to create additional detail memos about the same invoice or order ID shown in 910. When users have entered their memo entries inside 930, 942, or 950, the audit status for the invoice or order ID selected in 834 may be changed to “Normal” with a single click of 920, “On Hold” for a double-click of 920, triple-click for “Abnormal” of 920, or quadruple-click of 920 for “Not Done.”

In yet another exemplary embodiment, all entries—inputs, clicks, memos, or detail explanations—provided by users in the single page User Interface 500 are sent via one or more network connections 302 for System 400 to process and update for critical delivery information set and data analytics set.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system for auditing delivery completion, the system comprising:
a display;
a memory storing instructions; and
at least one processor configured to execute the instructions to perform steps comprising:
receiving an invoice ID of a customer based on a delivery address of the customer from a first database;
receiving a delivery completion picture associated with the invoice ID from a second database, wherein the delivery completion picture is of a desired location at the customer delivery address;
receiving delivery information from a third database, the delivery information including the desired location at the customer delivery address;
generating a delivery information set and a data analytics set based on the invoice ID, the delivery completion picture, and the delivery information;
generating a single page user interface including information from the delivery information set and the data analytics set;
displaying the single page user interface on the display, wherein the single page user interface comprises:
a search criteria view configured with user interface elements to narrow a search in the delivery information set by a user;
a delivery view configured to dynamically display a first list view based on the search in the delivery information set from the user interface elements in the search criteria view, and further dynamically display an invoice delivery view based on a selection in the first list view by the user;
a picture focused view wherein the picture focus view further enables audit of the delivery completion picture; and wherein the delivery completion picture indicates an audit status by displaying an oval shape having one of a plurality of colors respectively corresponding to different audit statuses; and
a first audit view is configured to dynamically display an audit history view based on a selection in the invoice delivery view by the user;
wherein the single page user interface is configured to receive inputs from the user in the search criteria view, the delivery view, and the first audit view, and update the user interface in response to the received inputs; and
converting at least one of the invoice ID, the delivery completion picture, the delivery information, the delivery information set, and the data analytics set from an original format to a conversion format for manipulation.

2. The system of claim 1, wherein the delivery information set includes at least one of an invoice ID, an order ID, a delivery completion picture, and the delivery information.

3. The system of claim 1, wherein the data analytics set includes at least one of a percentage of successful deliveries, a percentage of unsuccessful deliveries, and a total number of completed deliveries by dates.

4. The system of claim 1, wherein at least one of the delivery information set and the data analytics set is dynamically updateable based on at least one of new and revised delivery information, a new invoice ID, and a new delivery completion picture.

5. (canceled)

6. (canceled)

7. (canceled)

8. The system of claim 1, wherein the search criteria view includes a target search box configured to receive, from the user, an input of at least one invoice ID.

9. (canceled)

10. The system of claim 1, wherein the invoice delivery view further enables audit of the delivery completion picture.

11. A computer-implemented method for delivery completion audit tool, the method comprising:
receiving an invoice ID of a customer based on a delivery address of the customer from a first database;
receiving a delivery completion picture associated with the invoice ID from a second database, wherein the delivery completion picture is of a desired location at the customer delivery address;
receiving delivery information from a third database, the delivery information including the desired location at the customer delivery address;
generating a delivery information set and a data analytics set based on the invoice ID, the delivery completion picture, and the delivery information;
generating a single page user interface including information from the delivery information set and the data analytics set;
displaying the single page user interface on the display, wherein the single page user interface comprises:
a search criteria view configured with user interface elements to narrow a search in the delivery information set by a user;
a delivery view configured to dynamically display a first list view based on the search in the delivery information set from the user interface elements in the search criteria view, and further dynamically display an invoice delivery view based on a selection in the first list view by the user;
a picture focused view wherein the picture focus view further enables audit of the delivery completion picture; and wherein the delivery completion picture indicates an audit status by displaying an oval shape having one of a plurality of colors respectively corresponding to different audit statuses; and
a first audit view is configured to dynamically display an audit history view based on a selection in the invoice delivery view by the user; and
wherein the single page user interface is configured to receive inputs from the user in the search criteria view, the delivery view, and the first audit view, and update the user interface in response to the received inputs; and
converting at least one of the invoice ID, the delivery completion picture, the delivery information, the delivery information set, and the data analytics set from an original format to a conversion format for manipulation.

12. The method of claim 11, wherein the delivery information set includes at least one of an invoice ID, an order ID, a delivery completion picture, and the delivery information.

13. The method of claim 11, wherein the data analytics set includes at least one of a percentage of successful deliveries, a percentage of unsuccessful deliveries, and a total number of completed deliveries by dates.

14. The method of claim 11, wherein at least one of the delivery information set and the data analytics set is dynamically updateable based on at least one of new and revised delivery information, a new invoice ID, and a new delivery completion picture.

15. (canceled)

16. (canceled)

17. (canceled)

18. The method of claim 11, wherein the search criteria view includes a target search box configured to receive, from a user, an input of at least one invoice ID.

19. (canceled)

20. A computer-implemented system for delivery completion audit tool, the system comprising:
a memory storing instructions; and
at least one processor configured to execute the instructions to perform steps comprising:
receiving an invoice ID of a customer based on a delivery address of the customer from a first database;
receiving a delivery completion picture associated with the invoice ID from a second database, wherein the delivery completion picture is of a desired location at the customer delivery address;
receiving delivery information from a third database, the delivery information including the desired location at the customer delivery address;
generating a-delivery information set and a data analytics set based on the invoice ID, the delivery completion picture, and the delivery information;
generating a single page user interface including information from the delivery information set and the data analytics set;
displaying the single page user interface on the display, wherein the single page user interface comprises:
a search criteria view configured with user interface elements to narrow a search in the delivery information set by a user;
a picture focused view wherein the picture focus view further enables audit of the delivery completion picture; and wherein the delivery completion picture indicates an audit status by displaying a oval shape having one of a plurality of colors respectively corresponding to different audit statuses; and
a delivery view configured to dynamically display a first list view based on the search in the delivery information set from the user interface elements in the search criteria view, and further dynamically display an invoice delivery view based on a selection in the first list view;
wherein the first list view includes the delivery completion picture and an audit status;
wherein the single page user interface is configured to receive from the user at least one click on the delivery completion picture of the first list view to change the audit status, and update the audit status associated with the invoice ID in the user interface in response to the user at least one click; and
converting at least one of the invoice ID, the delivery completion picture, the delivery information, the delivery information set, and the data analytics set from an original format to a conversion format for manipulation.

21. The system of claim 1, wherein manipulation includes indexing data, rearranging data, filtering data, transforming data, and standardizing data.

22. The computer-implemented method of claim 11, wherein manipulation includes indexing data, rearranging data, filtering data, transforming data, and standardizing data.
